(19) United States
(12) Patent Application Publication
(10) Pub. No.: US 2026/0266101 A1
(43) Pub. Date: Sep. 10, 2026

(54) PEDESTRIAN PROTECTION SYSTEM STRUCTURED CONFIGURATIONS FOR HOOD LATCHES

(71) Applicant: MAGNA CLOSURES INC., Newmarket (CA)

(72) Inventor: Thomas KLEIN, Newmarket (CA)

(21) Appl. No.: 19/557,106

(22) Filed: Mar. 4, 2026

Related U.S. Application Data
(60) Provisional application No. 63/767,747, filed on Mar. 6, 2025.

(51) Int. Cl. E05B 77/08; B60R 21/34; E05B 83/24

(52) U.S. Cl. CPC E05B 77/08; B60R 21/34; E05B 83/243

(57) ABSTRACT

A latch system for mounting a latch assembly to a vehicle body. The latch system includes a bracket assembly for mounting to the vehicle body. The latch assembly includes a ratchet for latching to a striker on a closure panel. A connection between the latch assembly and the bracket assembly, and a bias member to cause the latch assembly to pivot relative to the bracket assembly about the connection. The bias member configured to push on the striker that is retained by the ratchet in a striker retaining position to move the closure panel from a closed position to a partially open, pop-up position.

### CROSS-REFERENCE TO RELATED APPLICATIONS

This application claims the benefit of U.S. Provisional Application Serial No. 63/767,747, filed March 6, 2025, which is incorporated herein by reference in its entirety.

### FIELD

The present disclosure generally relates to a power-operated closure latch assembly for a motor vehicle closure system. More specifically, the present disclosure is directed to a closure latch assembly providing power release pedestrian protection functionality and which is well-suited for use with a front hood latching system in a motor vehicle.

### BACKGROUND

It is desired to best protect pedestrians against injury resulting from head on collisions with vehicles. When a car hits a pedestrian in a front end collision, the pedestrian can be thrown up and land on the front hood of the vehicle. In an effort to lessen the harshness of the impact of the pedestrian against the vehicle, and in particular to prevent the person's head from impacting the engine block or other hard object located directly beneath the front hood, it would be desirable to actively space the front hood from the engine block prior to the pedestrian impacting the front hood. In particular, when a front end collision is imminent, it would be desirable to move the front hood in a very short period of time (e.g., in milliseconds) from a fully closed first position, where the front hood is normally located immediately adjacent the engine block, to a second position where the front hood is actively and controllably moved further away from the engine block. The movement of the hood to the second position could provide the pedestrian's head and/or body with sufficient time and/or cushion space to more gradually decelerate as the pedestrian impacts the front hood, thereby potentially lessening the risk of severe injury to the pedestrian.

It is further desired to minimize the cost and complexity of motor vehicle safety systems and components thereof. Further yet, it is desired to be able to provide an ability to drive a vehicle away from an accident site without reasonable concern of the damaged hood opening while driving or otherwise transporting the vehicle. Additionally, it is desired to be able to minimize the number of components needed to be replaced upon actuation of the vehicle safety system. It is further desired to ensure sufficient and ample time exists to fully deploy the motor vehicle safety system prior to a person impacting the front hood of the vehicle, thereby minimizing the potential seriousness of injury to the person. These desires, problems and others associated with accidents causing damage to a hood are recognized, as would be readily understood by those skilled in the art of vehicle closure panels.

Desired is a hood latch and system therewith which provides solutions to these issues, as well as other issues understood by a person skilled in the art of vehicle hood panels.

### SUMMARY

This section provides a general summary of the inventive solutions associated with the present disclosure. Accordingly, this section is not intended to be interpreted as a comprehensive and exhaustive listing of all features, aspects, objectives and/or advantages associated with the inventive solutions which are further described and illustrated in the following detailed description and the appended drawings.

It is an objective of the present disclosure to provide a pedestrian protection system (PPS) for use with a front hood latching system of a motor vehicle which addresses at least those issues discussed above.

It is a related objective of the present disclosure to further provide a pedestrian protection system for use with any latch, existing or new, of a motor vehicle.

It is a related objective of the present disclosure to further provide a pedestrian protection system for a motor vehicle hood latch for use with front trunk (frunk) hood.

In accordance with these and other objectives, it is an aspect of the present disclosure to provide a pedestrian protection system (PPS) that minimizes the number of components required to move a hood of a motor vehicle from a fully closed position to a pop-up position in response to an imminent impact.

In accordance with another aspect of the disclosure, a system for mounting a latch assembly to a vehicle body includes a bracket assembly for mounting to the vehicle body and a latch assembly having a ratchet for latching to a striker on a closure panel. Further, a kinematic connection between the latch assembly and the bracket assembly is provided. Further yet, an actuation member to cause the latch assembly to move, for example to pivot, relative to the bracket assembly in response to an active pedestrian protection mode of the latch system, wherein the actuation member is configured to push on the striker that is retained by the ratchet in a striker retaining position to move the closure panel from a closed position to a partially open position in the active pedestrian protection mode.

In accordance with another aspect of the disclosure, the actuation member is configured to cause the striker to pull on the ratchet to cause the latch assembly to pivot relative to the bracket assembly.

In accordance with another aspect of the disclosure, the latch assembly includes mounting apertures for receiving fasteners to also be received in apertures of the bracket assembly.

In accordance with another aspect of the disclosure, the pivot connection is between a body side bracket assembly connected to the vehicle body and a latch side bracket assembly connected to the latch assembly.

In accordance with another aspect of the disclosure, the latch side bracket assembly includes carrier plates configured to be fixed against movement relative to the latch assembly on opposite sides of the latch assembly and the body side bracket assembly includes mount plates configured to be fixed against movement relative to the vehicle body, wherein the pivot connection allows the carrier plates to pivot relative to the mount plates when the latch assembly pivots relative to the bracket assembly.

In accordance with another aspect of the disclosure, the actuation member includes a spring fixed to a drive lever, and a lock mechanism movable between a locked state, whereat the spring is maintained in a non-deployed position to prevent the latch assembly from pivoting relative to the bracket assembly, and an unlocked state, whereat the spring moves to a deployed position to bring the drive lever into forcible engagement with the striker to pivot the latch assembly relative to the bracket assembly.

In accordance with another aspect of the disclosure, a blocking lever is mounted to the bracket assembly for pivotal movement between a blocking position, whereat the blocking lever is aligned for abutment with a flange of the latch assembly to prevent pivoting of the latch assembly relative to the bracket assembly, and an unblocking position, whereat the blocking lever is moved out of alignment with the flange to allow pivoting of the latch assembly relative to the bracket assembly.

In accordance with another aspect of the disclosure, a power actuator is arranged to act directly on the lock mechanism to move the lock mechanism about an axis of the drive lever from the locked state to the unlocked state.

In accordance with another aspect of the disclosure, the spring moves from the deployed position to the undeployed position, the lock mechanism moves from the unlocked state to the locked state, and the blocking lever moves from the unblocking position to the blocking position upon moving the closure panel from the partially raised position to the closed position.

In accordance with another aspect of the disclosure, the spring is adapted to misalign from the striker after the striker has been moved to the deployed position to allow the latch assembly to pivot back to a non-deployed position.

In accordance with yet another aspect, there is provided a latch system for mounting a latch assembly to a vehicle body, the latch assembly comprising a frame plate, and a ratchet supported on the frame plate, the ratchet for releasably retaining with a striker mounted on a closure panel, the system including a bracket assembly for mounting to the vehicle body, the bracket assembly having a pair of mount plates, a carrier assembly for mounting to the latch assembly, the bracket assembly having a pair of carrier plates, wherein the latch assembly is positioned between the pair of carrier plates, a connection between the latch assembly and the bracket assembly, the connection for guiding the movement of the carrier assembly relative to the bracket assembly; and a bias member having a first end mounted to the bracket assembly, and a second end for engaging with the striker to cause the latch assembly and the carrier assembly to pivot relative to the bracket assembly in response to an active pedestrian protection mode of the latch system, wherein the bias member is configured to apply a force on the striker that is retained by the ratchet in a striker retaining position to move the closure panel from a closed position to a partially open position in the active pedestrian protection mode.

Further areas of applicability will become apparent from the description provided herein. The description and specific examples in this summary are only intended to illustrate certain non-limiting objects, aspects, and embodiments which are not intended to limit the scope of the present disclosure.

### BRIEF DESCRIPTION OF THE DRAWINGS

The drawings described herein are only intended to illustrate non-limiting embodiments of a power-operated closure latch assembly and its related structural configuration and functional operation in association with the teachings of the present disclosure. In the drawings:

FIG. 1 illustrates a portion of a motor vehicle having a pedestrian protection system constructed according to one aspect of the present disclosure, with the pedestrian protection system shown in a nondeployed state with a latch of the motor vehicle shown in a fully latched, closed position to maintain a closure panel in a fully closed position relative to a body of the motor vehicle;

FIG. 2 is a view similar to FIG. 1 with the pedestrian protection system shown in a deployed state with the latch shown in the fully latched, closed position to maintain the closure panel in a partially open position relative to the body of the motor vehicle;

FIG. 3 is a perspective view of a closure latch assembly of the motor vehicle of FIG. 1; and

FIG. 4 is a perspective view of a closure latch assembly having a pedestrian protection system constructed in accordance with another aspect of the disclosure.

### DETAILED DESCRIPTION OF EXAMPLE EMBODIMENTS

Example embodiments of a power-operated pedestrian protection system (PPS) for use with a closure latch assembly of a closure latch system of a motor vehicle will now be described more fully with reference to the accompanying drawings. To this end, the example embodiments of the closure latch system and closure latch assembly are provided so that the disclosure will be thorough and will fully convey its intended scope to those who are skilled in the art. Accordingly, numerous specific details are set forth such as examples of specific components, devices, and methods, to provide a thorough understanding of particular embodiments of the present disclosure. However, it will be apparent to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

In the following detailed description, the expression “closure latch assembly” will be used to generally indicate any power-operated latch device adapted for use with a vehicle closure panel. Additionally, the expression “closure panel” will be used to indicate any element mounted to a structural body portion of a motor vehicle and which is movable between a fully-open position, a partially open pop-up position, and a fully-closed position, respectively opening and closing an access to a passenger or storage compartment of the motor vehicle. Without limitations, closure panel herein is described in relation to front hoods of motor vehicles.

The terminology used herein is for the purpose of describing particular example embodiments only and is not intended to be limiting. As used herein, the singular forms "a," "an," and "the" may be intended to include the plural forms as well, unless the context clearly indicates otherwise. The terms "compromises," "comprising," "including," and "having," are inclusive and therefore specify the presence of stated features, integers, steps, operations, elements, and/or components, but do not preclude the presence or addition of one or more other features, integers, steps operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," "engaged to," "connected to," or "coupled to" another element or layer, it may be directly on, engaged, connected or coupled to the other element or layer, or intervening elements or layers may be present. In contrast, when an element is referred to as being "directly on," directly engaged to," "directly connected to," or "directly coupled to" another element or layer, there may be no intervening elements or layers present. Other words used to describe the relationship between elements should be interpreted in a like fashion (e.g., "between" versus "directly between," "adjacent" versus "directly adjacent," etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as "first," "second," and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as "inner," "outer," "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

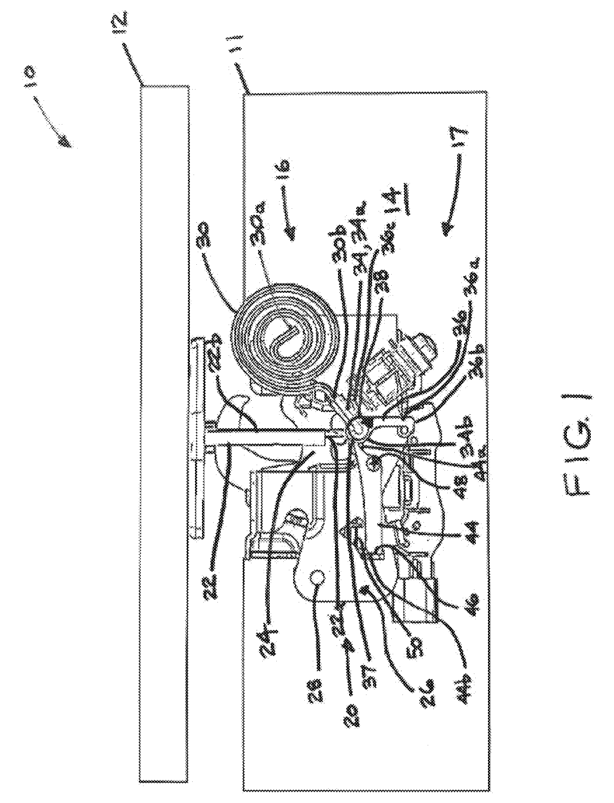

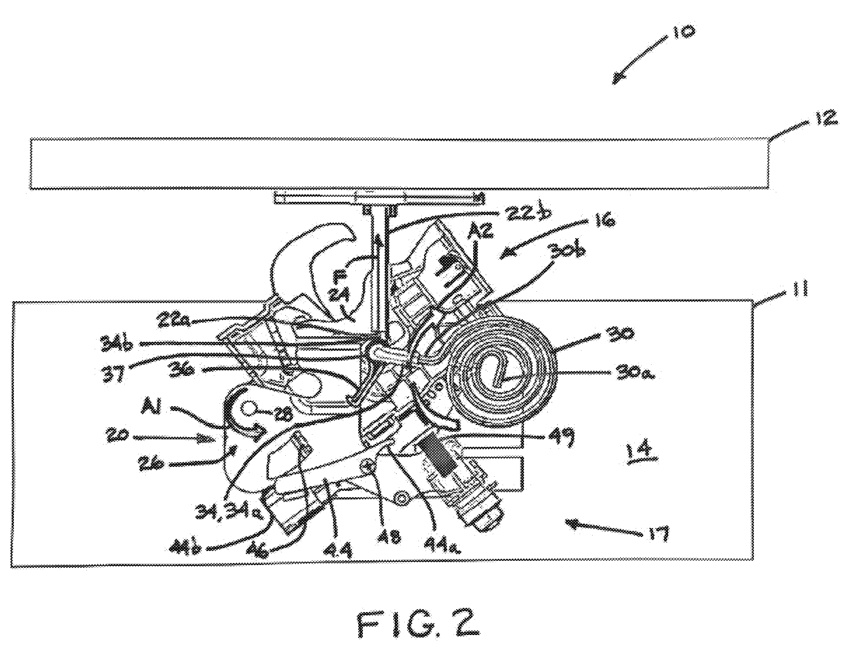

FIG. 1 illustrates a portion of a motor vehicle 10 having a body 11 defining a front compartment 14, which in some embodiments may be an engine compartment and in other embodiments may be a storage compartment, otherwise known as a front trunk, sometimes referred to as “frunk.” In this non-limiting example of motor vehicle 10, a closure panel, configured as a front hood, also referred to simply as hood 12, is pivotably mounted to body 11 for movement relative to the front compartment between a fully-closed position FIG. 1, a partially open or pop-up position FIG. 2, and a fully open position. Illustratively, the closure panel 12 is a hood provided at the front of the motor vehicle 10 for enclosing an engine bay or a frunk, also referred to as storage compartment. Hood 12 may be manually released from within a passenger compartment of vehicle 10 and which functions to actuate a latch release mechanism associated with a closure latch assembly 16 for releasing hood 12 and permitting subsequent movement of hood 12 to its pop-up position or to its fully open position. Closure latch assembly 16 is, in this non-limiting embodiment, secured to a structural portion of vehicle body 11 adjacent to the front compartment and is configured to releasably engage a striker 22 mounted in fixed relation to an underside of hood 12. The present disclosure is directed to providing a pedestrian protection system, also referred to as pedestrian protection system (PPS), and also referred to herein simply as system 20, configured to cooperate in operable communication with closure latch assembly 16 to form a closure latch system 17, with a power release function (automatically actuatable via a sensor/controller system) to automatically move hood 12 from a fully closed position to the pop-up position in imminent anticipation of a pedestrian P coming into forcible contact with hood 12. Accordingly, if a pedestrian P impacts the hood 12 after actuation of PPS 20, a cushioned effect of the slightly raised hood 12 is provided, which lessens the impact force to the pedestrian, and can ultimately reduce the potential of the pedestrian P impacting the engine (if present beneath hood 12), thereby reducing the potential for injury to the pedestrian P.

A detailed description of a non-limiting embodiment of a power-operated version of closure latch assembly 16 and closure latch system 17, constructed in accordance with the teachings of the present disclosure, will now be provided with reference to FIGS. 1 through 3. Pedestrian protection system (PPS) 20 is readily adaptable for use with an existing closure latch assembly, referred to hereafter as latch 16, or integrated as a component of a latch 16 originally installed in a new motor vehicle 10. Latch 16 includes a ratchet 24 and at least one pawl. One example of a latch having such a ratchet and pawl configuration is shown and described in US20200217110A1 titled “Vehicle hood latch and method of unlatching a vehicle hood”, the entire contents of which are incorporated herein by reference. The ratchet 24 is movable between a primary closed position, also referred to as primary striker capture position, a secondary closed position, also referred to as secondary striker capture position, and an open position, also referred to as striker release position, in response to selective movement of the pawl(s). In the primary and secondary closed positions, the ratchet 24 prevents the withdrawal of the striker 22 from the latch 16. When in the primary closed position, the ratchet 24 holds the striker 22 relatively deeper within a slot, commonly referred to as a fishmouth of a latch housing, wherein the hood 12 is in a fully closed state, as compared to when ratchet 24 is in the secondary closed position, wherein the hood 12 is in the partially open state, but prevented from being moved to the fully open position by ratchet 24.

Pedestrian protection system 20 is provided for mounting a latch assembly 16 to the vehicle body 11, and includes a bracket assembly 26 for mounting to the vehicle body 11. Further, a connection is provided between the latch assembly 16 and the bracket assembly 26, which is illustratively shown as a pivot connection 28. Further yet, pedestrian protection system includes an actuation member, such as a bias member 30 for example, to selectively cause the latch assembly 16 to move, and in accordance with the illustrative example, to pivot from a normal use position (FIG. 1) relative to the bracket assembly 26 to a pedestrian protection position (FIG. 2) in response to an active pedestrian protection mode of the latch system 17. The bias member 30 is configured to apply a force on the striker 22, such as push with a force F (FIG. 2) on the striker 22 that is retained by the ratchet 24, while ratchet 24 is in the striker retaining position, whereupon the force F moves the closure panel 12 from the fully closed position to the partially open, pop-up position in the active pedestrian protection mode. The force F acts directly on the striker 22, causing the striker 22 and closure panel 12 fixed thereto to move forcibly upwards, whereupon the striker 22 pulls and drives the ratchet 24 upwardly, while in the striker capture position, thereby causing the latch 16 to pivot in a direction of arrow A1 about the pivot connection 28 relative to the bracket assembly 26. With the force F acting directly on the striker 22, reliable and simplified movement of the closure panel 12 to the partially open position is made possible, without requiring intermediate levers or mechanisms to be moved in chain reaction to cause movement of the closure panel 12. The actuation member, such as a bias member 30, may selectively cause the latch assembly 16 to move, in other manners, such as by causing the latch assembly 16 to undergo a sliding motion, provided by the connection as a sliding connection formed by a pin and slot arrangement for example, or a more complex motion, as provided by the connection having multiple pivot points, such as a four-bar connection in one possible example, to provide a more complex motion.

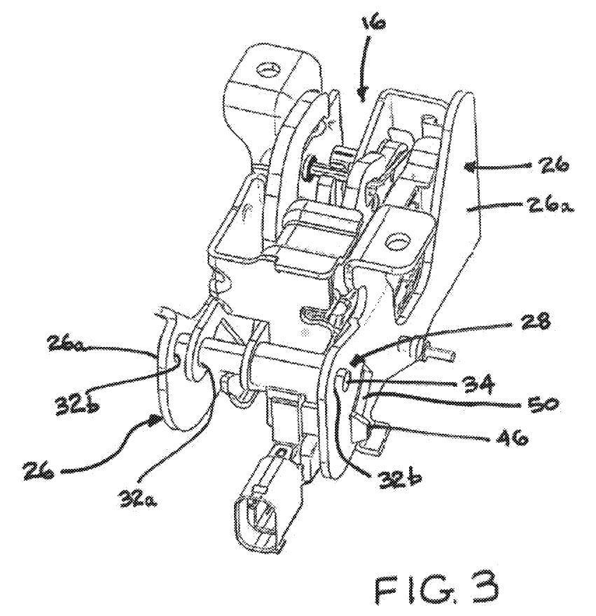

To facilitate pivotal coupling of the latch assembly 16 to the bracket assembly 26, the latch assembly 16 includes mounting apertures 32a (FIG. 3) for receiving at least one pivot pin 34 to also be received in apertures 32b of the bracket assembly 26. In the non-limiting embodiment of FIGS. 1-3, the bracket assembly 26 is provided by a pair of bracket plates 26a spaced from one another by the latch 16 sandwiched therebetween.

The bias member 30 is shown as a coil spring wound in spiral fashion, having a first end 30a fixed against movement and a second end 30b fixed to a generally L-shaped drive lever 34. A first leg 34a of the drive lever 34 is connected directly to the second end 30b of the spring 30, and a second leg 34b of drive lever, extending generally transversely to the first leg 34a, is configured for engagement with a bottom surface of the striker 22, with the second leg 34b extending generally parallel with a bottom intermediate leg 22a of striker 22, with the intermediate leg 22a extending between and connected to generally parallel upstanding legs 22b of striker 22.

A lock mechanism, also referred to as lock lever 36, is movable between a locked state (FIG. 1), whereat the spring 30 is maintained in a non-deployed position to prevent the latch assembly 16 from pivoting relative to the bracket assembly 26, and an unlocked state (FIG. 2), whereat the spring 30 moves to a deployed position to bring the drive lever 34 into forcible engagement with the striker 22 to pivot the latch assembly 16 relative to the fixed bracket assembly 26. Lock lever 36 is biased toward the locked state by a bias member, such as a torsion spring 38 (shown schematically in FIG. 1), by way of example and without limitation. Lock lever 36 is shown having a hub 37 supported for pivotal movement about the second leg 34b of drive lever 34, with lock lever 36 having a first leg 36a extending outwardly from the hub 37 to a J or L-shaped hook end 36b. Hook end 36b is biased via bias member 38 into locked engagement with a lock pin 40 extending laterally outwardly from bracket assembly 26 while lock lever 36 is in the locked state, whereat the spring 30 is maintained in a helically wound, non-deployed position to prevent the latch assembly 16 from pivoting relative to the bracket assembly 26. Lock lever 36 has a second leg 36c extending outwardly from the hub 37 in inclined relation with the first leg 36a. Second leg 36c is configured to be actuated via engagement with a power actuator 42 to initiate actuation of the pedestrian protection system 20, thereby causing latch 16 to pivot relative to bracket assembly 26 and move the closure member 12 to the partially open position, while ratchet 24 remains in the striker capture position, as discussed further below.

To prevent an inadvertent release of latch assembly 16 from fully latched, hood fully closed position to the pedestrian protection position of FIG. 2, a blocking lever 44 is mounted to the bracket assembly 26 for pivotal movement between a blocking position (FIG. 1), whereat the blocking lever 44 is aligned for abutment with a flange 46 of the latch assembly 16 to prevent pivoting of the latch assembly 16 relative to the bracket assembly 26, and a release position, also referred to as unblocking position, whereat the blocking lever 44 is pivotably moved about a pivot axis 48 out of alignment with the flange 46 to allow pivoting of the latch assembly 16 relative to the bracket assembly 26. The blocking lever 44 has an activation leg 44a at one end and a blocking surface 44b at an opposite end, with the pivot axis 48 located therebetween.

In use, while latch assembly 16 is in the normal operating position (FIG. 1), upon a pedestrian having entered pedestrian protection zone, as discussed in co-owned US Application having serial number 17/576,811, filed on January 14, 2022 and issued as US Pat. No. 11,781,349, the content of which is incorporated herein by way of reference in its entirety, a sensor detects an imminent side or frontal crash/impact with pedestrian, thus, causing sensor to communicate with a vehicle controller and/or directly with a latch controller to actuate power actuator 42 of pedestrian protection feature 20 to automatically cause a plunger 49 of power actuator 42 to act directly on and forcibly impact the second leg 36c of lock lever 36, thereby causing lock lever 36 to pivot from the locked state about a central hub axis of hub 37 against the bias imparted by bias member 38 to the unlocked state. Power actuator 42 may be provided as an electrical actuator such as a solenoid, or an actuator having stored potential energy that can be released, such as a pyrotechnic actuator, or spring, other type of actuator as but non-limiting examples. The pivotal movement of lock lever 36 causes the end 36b of first leg 36a to move out of locking engagement from lock pin 40, whereupon stored energy of bias member 30 is released to move the drive lever 34 in the direction of arrow A2, whereupon the second leg 34b of drive lever 34 is driven into forcible engagement with striker 22, thereby causing striker 22 and closure panel 12 to be urged upwardly. Simultaneously, hub 37 forcibly engages activation leg 44a of blocking lever 44 as hub 37 is urged upwardly by bias member 30, thereby causing blocking lever 44 to pivot about pivot axis 48 and move blocking surface 44b out from blocking relation with flange 46. As such, flange 46 of latch 16 is unobstructed and free to move with a slot 50 of bracket assembly 26 as striker 22 pulls upwardly on ratchet 24 while ratchet 24 remains in its striker capture position, thereby causing latch 16 to pivot from the normal operating position (FIG. 1) relative to bracket assembly 26 about pivot connection 28 to the pedestrian protection position (FIG. 2). In accordance with another possible configuration, plunger 49 may additionally act to also move the striker 22; actuation member, and for example bias member 30, may therefore be eliminated from the configuration described above. Bias member 30 may continue to move in a direction A2 past that position which is shown in FIG. 2 such that bias member 30 becomes misaligned from the striker 22 after the striker 22 has been moved to the deployed position. The bias member 30 in such a position no longer applies force to the striker 22 to allow the latch assembly 16 to pivot back to a non-deployed position.

After release of the closure panel 12 to the pedestrian protection position, with the latch 16 inclined relative to the bracket assembly 26 and while the ratchet 24 is in its striker capture position (FIG. 2), the closure panel 12 can be returned to the fully closed position, whereupon the spring 30 is moved from the deployed position back to the undeployed position, the lock mechanism 36 moves from the unlocked state to the locked state, and the blocking lever 44 moves from the unblocking position to the blocking position, thereby resetting the pedestrian protection system 20.

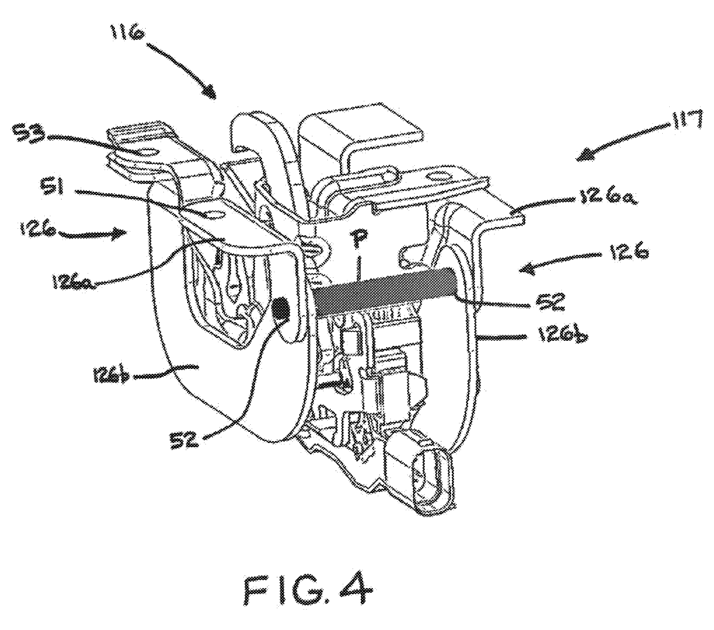

In FIG. 4, a closure latch system 117 in accordance with another aspect of the disclosure is shown, wherein like numbers, offset by a factor of 100, are used to identify like features. The difference of closure latch system 117 compared to closure latch system 17 of FIGS. 1-3 is with regard to a bracket assembly 126. Rather than the bracket assembly 126 having a pair of single piece plates disposed on opposite sides of a latch assembly 116, bracket assembly 126 has a pair of mount plates, also referred to as body brackets 126a, configured for fixed connection to the vehicle body 11 via openings 51 and fasteners (not shown) disposed therethrough, thereby fixing body brackets 126a against movement relative to the vehicle body 11, and carrier plates, also referred to as latch brackets 126b, configured for connection to the latch assembly 116 via openings 53 and fasteners (not shown) disposed therethrough, thereby fixing the latch bracket 126b against movement relative to the latch assembly 116. The latch bracket 126b can be formed as a single piece of material or as a pair of separate pieces of material disposed along opposite side of latch assembly 116. The latch assembly 16 is positioned between the pair of carrier plates 126b. The latch assembly 16 is illustratively shown in FIG. 4 as positioned between the pair of carrier plates 126b and the pair of mount plate 126a. A pivot connection 128 is provided between the body brackets 126a and the latch bracket(s) 126b via a pin P extending through axially aligned openings 52 in the body brackets 126a and the latch bracket(s) 126b. As such, latch bracket(s) 126b and latch assembly 116, fixed against movement relative to one another, are able to freely pivot relative to the body brackets 126a fixed to vehicle body 11 during movement of latch assembly 116 to the pedestrian protection position, as discussed above for latch assembly 16.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch system for mounting a latch assembly to a vehicle body comprising:
a bracket assembly for mounting to the vehicle body;
the latch assembly comprising a ratchet for latching to a striker on a closure panel;
a connection between the latch assembly and the bracket assembly; and
an actuation member to cause the latch assembly to pivot relative to the bracket assembly in response to an active pedestrian protection mode of the latch system, wherein the actuation member is configured to push on the striker that is retained by the ratchet in a striker retaining position to move the closure panel from a closed position to a partially open position in the active pedestrian protection mode.

2. The latch system of claim 1, wherein the connection is a pivot connection, and the actuation member comprises a bias member that is configured to cause the striker to pull on the ratchet to cause the latch assembly to pivot relative to the bracket assembly.

3. The latch system of claim 1, wherein the latch assembly includes mounting apertures for receiving fasteners to also be received in apertures of the bracket assembly.

4. The latch system of claim 1, wherein the pivot connection is between a body bracket of the bracket assembly connected to the vehicle body and a latch bracket of the bracket assembly connected to the latch assembly.

5. The latch system of claim 4, wherein the latch bracket includes carrier plates configured to be fixed against movement relative to the latch assembly on opposite sides of the latch assembly and the body bracket includes mount plates configured to be fixed against movement relative to the vehicle body, wherein the pivot connection allows the carrier plates to pivot relative to the mount plates when the latch assembly pivots relative to the bracket assembly.

6. The latch system of claim 1, wherein the actuation member includes a spring fixed to a drive lever, and a lock mechanism movable between a locked state, whereat the spring is maintained in a non-deployed position to prevent the latch assembly from pivoting relative to the bracket assembly, and an unlocked state, whereat the spring moves to a deployed position to bring the drive lever into forcible engagement with the striker to pivot the latch assembly relative to the bracket assembly.

7. The latch system of claim 6, further including a blocking lever mounted to the bracket assembly for pivotal movement between a blocking position, whereat the blocking lever is aligned for abutment with a flange of the latch assembly to prevent pivoting of the latch assembly relative to the bracket assembly, and an unblocking position, whereat the blocking lever is moved out of alignment with the flange to allow pivoting of the latch assembly relative to the bracket assembly.

8. The latch system of claim 7, further including a power actuator arranged to act directly on the lock mechanism to move the lock mechanism about an axis of the drive lever from the locked state to the unlocked state.

9. The latch system of claim 7, wherein the spring moves from the deployed position to the undeployed position, the lock mechanism moves from the unlocked state to the locked state, and the blocking lever moves from the unblocking position to the blocking position upon moving the closure panel from the partially raised position to the closed position.

10. The latch system of claim 1, wherein the actuation member includes a bias member that is adapted to misalign from the striker after the striker has been moved to the deployed position to allow the latch assembly to pivot back to a non-deployed position.

11. A latch system for mounting a latch assembly to a vehicle body, the latch assembly comprising a frame plate, and a ratchet supported on the frame plate, the ratchet for releasably retaining with a striker mounted on a closure panel, the system comprising:
a bracket assembly for mounting to the vehicle body, the bracket assembly having a pair of mount plates;
a carrier assembly for mounting to the latch assembly, the bracket assembly having a pair of carrier plates, wherein the latch assembly is positioned between the pair of carrier plates;
a connection between the latch assembly and the bracket assembly, the connection for guiding the movement of the carrier assembly relative to the bracket assembly; and
a bias member having a first end mounted to the bracket assembly, and a second end for engaging with the striker to cause the latch assembly and the carrier assembly to pivot relative to the bracket assembly in response to an active pedestrian protection mode of the latch system, wherein the bias member is configured to apply a force on the striker that is retained by the ratchet in a striker retaining position to move the closure panel from a closed position to a partially open position in the active pedestrian protection mode.
